(19) United States
(12) Patent Application Publication
(10) Pub. No.: US 2016/0328501 A1
(43) Pub. Date: Nov. 10, 2016

(54) Automatic AMP Matching

(71) Applicant: Fractal Audio Systems, Plaistow, NH (US)

(72) Inventor: Clifford Chase, Plaistow, NH (US)

(21) Appl. No.: 15/145,511

(22) Filed: May 3, 2016

Related U.S. Application Data
(60) Provisional application No. 62/156,984, filed on May 5, 2015.

(51) Int. Cl. G06F 17/50

(52) U.S. Cl. CPC G06F 17/5009

(57) ABSTRACT

An amplifier or other device under test (DUT) may be automatically modeled. A first simulation model of a first device is provided. One or more processors may be used to measure characteristics of the DUT, the characteristics including two or more of equalization, gain, distortion, and compression. The measured characteristics of the DUT are compared with the characteristics of the first simulation model, and corrective data is calculated based on the comparison. The corrective data is used along with the first simulation model to create a corrected model. The corrected model may be used to filter input signals. Where the DUT is an amplifier, sounds produced by an instrument coupled to the one or more processors produce a sound resembling that of the instrument played through the DUT.

### CROSS REFERENCE TO RELATED APPLICATIONS

This application claims priority to co-pending U.S. Provisional Application entitled, “Automatic Amp Matching,” having Ser. No. 62/156,984, filed May 5, 2015, which is entirely incorporated herein by reference.

### BACKGROUND

Modern tube amplifier simulators mostly operate using the fundamental paradigm of an input equalizer followed by a dynamic waveshaper followed by an output equalizer. The input equalization is comprised of any fixed filtering plus any user adjustable filtering, if any. User adjustable filtering typically involves tone controls and switches. Likewise, output equalization is comprised of any fixed filtering plus any user adjustable filtering which, again, may be tone controls or switches. In addition the output equalization comprises the frequency response of the tube power amp due to the reactive speaker load.

A dynamic waveshaper simulates the distortion that occurs when the various active components in a tube amp enter their regions of nonlinear operation and thereby generate distortion. A power supply in a tube amp is typically poorly regulated which results in significant droop or sag which in turn causes an increase in distortion. This is simulated using a dynamic waveshaper as opposed to a static waveshaper. Dynamic waveshapers are static waveshapers where the gain is dependent upon the statistics of the input or output signal. For example, one common approach is to measure the RMS voltage of the input signal and increase the input gain of the waveshaper proportionally and decrease the output gain by the same proportion. This creates a dynamic increase in gain and output compression.

Due to a multitude of factors no amplifier simulator can perfectly predict the input equalization (EQ), output EQ or waveshaper parameters. These factors include component tolerances and parasitics as well as variations in the speaker impedance.

### SUMMARY

The proposed invention describes a method whereby corrective data is generated and stored which corrects the base amplifier simulation model such that the resulting model is virtually indistinguishable for the particular amplifier used to generate the data.

Tube amplifier simulation has reached a point where a virtual amplifier can be made from a schematic and the resulting “model” is reasonably similar to the amplifier being simulated. However, variations in component tolerance, tube characteristics and parasitic elements prevent a perfect match from being achieved without analysis of the actual amplifier. Furthermore no two amps are exactly the same due to the aforementioned variations. Vintage tube amplifiers are especially prone to variation due to component aging and the point-to-point wiring used in their construction.

Guitar players typically develop an affinity or affection for their personal amplifiers and will often say that their particular copy of a particular model of amplifier is superior to other copies. Therefore the ultimate goal of a simulator is to recreate the sound and behavior of a particular amplifier as closely as possible.

Modern amplifier simulators usually consist of several or more “models” which are representations of a particular amplifier. For example most modern simulators contain a Fender Deluxe Reverb model. This model would be representative of a typical Deluxe Reverb but not necessarily representative of a particular Deluxe Reverb that may, for whatever reasons, be considered superior.

The aforementioned variations in a tube guitar amplifier create several primary metrics that determine the final response of the amplifier. These metrics are the frequency response, gain, distortion curve and compression characteristics. Human audio perception is such that these are the most important metrics in discerning one amplifier from another. If these metrics are replicated in the model, the average human cannot discern between the model and the real amplifier.

This disclosure presents a method for obtaining those metrics and generating a set of corrective coefficients to apply to the amplifier simulation model. Furthermore this technique allows the user to perform the procedure and store the results on the simulation platform whether that is a hardware or software device.

One aspect of the disclosure provides a method, comprising storing a first simulation model of a first device, and measuring, with one or more processors, characteristics of a device under test (DUT), the characteristics including two or more of equalization, gain, distortion, and compression. The one or more processors compare the measured characteristics of the DUT with the characteristics of the first simulation model, calculate corrective data based on the comparison, and create a corrected model based on the corrective data and the first simulation module. In some examples, the method may further comprise measuring characteristics of the corrected model, comparing the measured characteristics of the DUT with the measured characteristics of the corrected model, calculating second corrective data based on the comparison, and updating the corrected model based on the second corrective data. Measuring the characteristics of the corrected simulation model may be performed before, after, or simultaneously with the measuring of the DUT.

Another aspect of the disclosure provides a system, comprising a memory storing a first simulation model of a device, and one or more processors in communication with the memory. The one or more processors may be programmed to measure characteristics of a device under test (DUT), the characteristics including two or more of equalization, gain, distortion, and compression, measure characteristics of the first simulation model, compare the measured characteristics of the DUT with the characteristics of the first simulation model, calculate corrective data based on the comparison, and create a corrective model based on the corrective data and the first simulation model. The first device may be, for example, an amplifier and/or a speaker. The one or more processors may include digital signal processors.

Yet another aspect of the disclosure provides a nontransitory computer-readable storage medium storing instructions executable by one or more processors for performing a method of signal processing. The method comprises storing a first simulation model of a first device, measuring characteristics of a device under test (DUT), the characteristics including two or more of equalization, gain, distortion, and compression, comparing the measured characteristics of the DUT with the characteristics of the first simulation model, calculating corrective data based on the comparison, and creating a corrected model based on the corrective data and the first simulation model. In one example, comparing the characteristics of the DUT with the characteristics of the first simulation model comprises matching transfer functions of the DUT with transfer functions of the first simulation model.

A further aspect of the disclosure provides a method of manufacturing a simulation device, comprising storing a first simulation model of a first device, providing an input for receiving information from a device under test (DUT), and providing one or more processors. The one or more processors may be programmed to measure the received information, determine characteristics of the DUT based on the received information, the characteristics including two or more of equalization, gain, distortion, and compression, compare the measured characteristics of the DUT with the characteristics of the first simulation model, calculate corrective data based on the comparison, and create a corrected model based on the corrective data and the first simulation module.

Another aspect of the disclosure provides a method of simulating a device under test (DUT). This method comprises selecting, on a signal processing device, a first simulation model having characteristics approximating characteristics of the DUT. The method further includes inputting information from the DUT to the signal processing device, and inputting at least one command. The at least one command causes one or more processors in the signal processing device to measure the information from the DUT, determine characteristics of the DUT based on the information, the characteristics including two or more of equalization, gain, distortion, and compression, compare the measured characteristics of the DUT with the characteristics of the first simulation model, calculate corrective data based on the comparison, and create a corrected model based on the corrective data and the first simulation module.

### BRIEF DESCRIPTION OF THE DRAWINGS

FIG. 1 is an example block diagram of a corrected simulation model according to aspects of the disclosure;

FIG. 2 is an example block diagram of a frequency measurement model according to aspects of the disclosure;

FIG. 3 is an example line graph according to aspects of the disclosure;

FIG. 4 is an example block diagram of a compression measurement model according to aspects of the disclosure;

FIG. 5 illustrates example input and output waveforms according to aspects of the disclosure;

FIG. 6 is a block diagram of an example system according to aspects of the disclosure; and

FIG. 7 is a flow diagram of an example method according to aspects of the disclosure.

### DETAILED DESCRIPTION

The subject matter described herein relates to automatically matching the unique sound of a given amplifier using digital signal processing. As outlined prior there are four primary metrics: equalization, gain, distortion curve shape and compression characteristics. The equalization may be further divided into input EQ and output EQ. The proposed invention operates by learning corrective input and output EQ in addition to adjusting the internal parameters of the simulation model to match the distortion curve shape and compression characteristics to the particular amplifier.

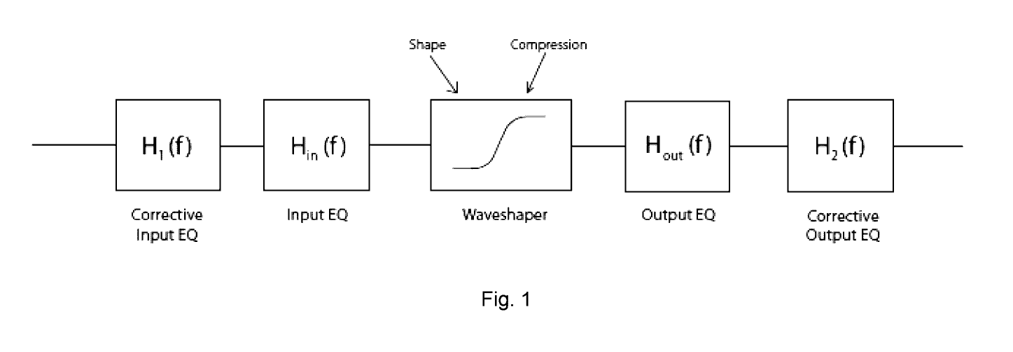

FIG. 1 provides an example corrected simulation model. In learning corrective input and output EQ, all distortion that occurs in a tube amplifier can be represented by a waveshaper with a monotonic sigmoid transfer function. This monotonic sigmoid shape results in a particular response that can be exploited for the purposes of isolating the resulting input and output equalization structures. Applying a sine wave to a monotonic sigmoid waveshaper results in a harmonic series of sine waves where the fundamental has the largest amplitude and that amplitude is constant versus frequency assuming that the amplitude at the input is large enough to cause the waveshaper to clip the signal. If the input signal amplitude is large enough the amplitude of the fundamental is constant with respect to frequency and applied amplitude.

The primary technique for learning the input and output EQ involves applying known stimulus to the amplifier and measuring the resulting frequency response. As stated prior, applying a sine wave to a sigmoid waveshaper results in a distorted sine wave. The Fourier transform of this distorted sine wave will be a harmonic series of sine waves. Since the waveshaper is monotonic the fundamental will always be the dominant member of the series. The harmonics will always be at a lesser amplitude. If the applied amplitude is above the clipping threshold the amplitude of the fundamental will be constant over frequency and input amplitude. Therefore the input to the output EQ can be assumed to be of constant amplitude.

A sine wave may be applied to the input to the device under test (DUT). The DUT may be, for example, an amplifier being simulated, a speaker, or a combination of these or other devices. Inputting the sine wave at a sufficiently high amplitude will cause the waveshaper to operate in its nonlinear regions of operation. It can be assumed that the waveshaper is reasonably stationary when stimulated by a constant power input. This implies that the output of the waveshaper at the fundamental frequency is therefore constant. This further implies that any measured variation from a constant value versus frequency is therefore the output EQ of the DUT. Therefore, applying a high amplitude input to the DUT, the output EQ curve can be obtained directly by measuring the frequency response. This can be done either using sine sweeps or stepped sine stimulus or other techniques. An FFT analysis may be performed to obtain discrete frequency measurements which can then be easily used in subsequent mathematical operations.

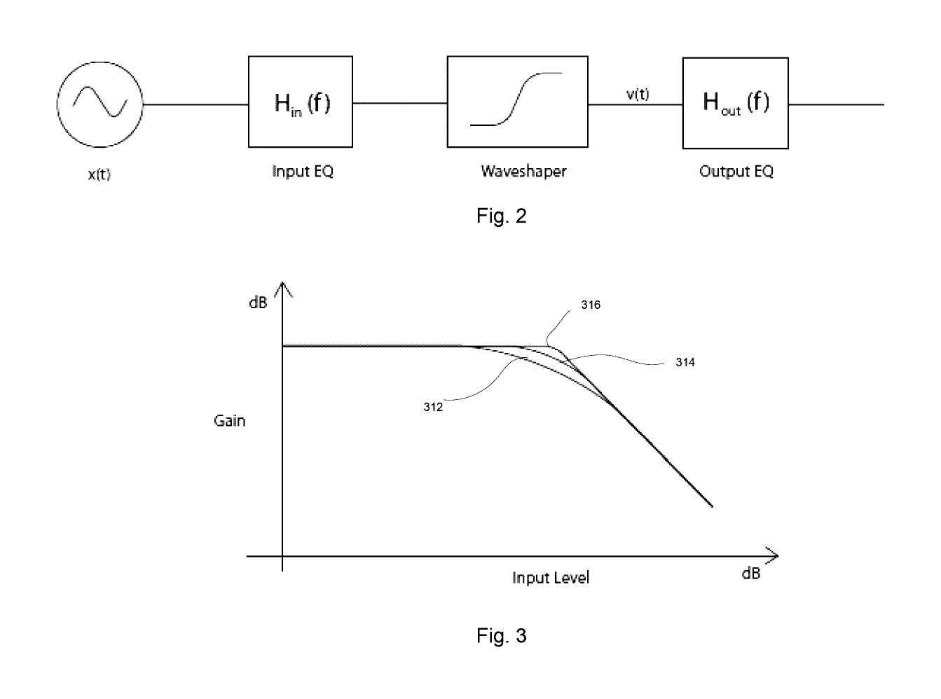

FIG. 2 further illustrates the features discussed above in connection with FIG. 1. If x(t) is a sine wave of sufficient amplitude to ensure that the waveshaper is clipping, then the signal v(t) will be a sum of sine waves:

v(t)=Σaₙsin(2nπft); n=1, 2, 3,

where an is the amplitude of each harmonic. The fundamental, a₁sin(2πft), is such that a₁ is constant over all frequencies of interest. Therefore, the signal v(t) can be considered to have a flat frequency response and thus the measured output frequency response is solely the response due to Hₒᵤₜ(f).

Applying a sine wave to the input of the DUT at an amplitude such that the DUT is always in its linear region results in a frequency response measurement of the entire DUT. However, having already obtained the output EQ, the input EQ can be obtained by dividing the output EQ by this measurement. In other words, the frequency response of the amplifier when operating in the linear region is the product of the input and output EQ, Hₜₒₜₐₗ=Hiₙ(f) Hₒᵤₜ(f). Stimulating the amplifier with a high amplitude sweep obtains Hₒᵤₜ(f). Stimulating the amplifier with a low amplitude sweep obtains Hₜₒₜₐₗ (f). Hᵢₙ(f) is then Htₒₜₐₗ(f)/Hₒᵤₜ(f).

Repeating the measurements on the simulation model will similarly yield input and output EQ transfer functions. These measurements can be run before, after, or simultaneously with the DUT measurements. Regardless of when, equivalent input and output EQ functions are also obtained for the simulation model. It is then a simple matter to calculate corrective equalization functions. For example, if we denote the output EQof the DUT as H₁_{_}ₒᵤₜ(f) and the output EQ of the simulation model as H₂_{_}ₒᵤₜ(f) then the corrective EQ function is simply H₂_{_}ₒᵤₜ(f) H₁_{_}ₒᵤₜ(f). The corrective input EQ is found in the same manner.

The distortion curve shape of an amplifier can be obtained by measuring the resulting gain of the amplifier versus input amplitude. Again, since the amplifier distortion characteristics resemble a monotonic sigmoid function the resulting gain will be a monotonic function.

The gain is a maximum when the amplifier is operating in the linear region. When the input amplitude is increased the amplifier begins to enter the nonlinear region of operation and the effective gain decreases since the output amplitude is limited and we define gain as the output amplitude divided by the input amplitude.

The shape of the distortion curve therefore defines the resulting shape of the gain versus input amplitude curve. The harder the “knee” on the sigmoid function, the harder the resulting knee on the gain vs. input amplitude curve. FIG. 3 shows three possible transfer functions with various hardness. For example, curve 312 includes a softer knee, while curves 314 and 316 are respectively harder.

While it is possible to calculate the shape of the sigmoid function based on the measured curve it is easier to simply compare the shape of the DUT transfer function to the simulation model. The “hardness” of the model can then be adjusted until the difference between the DUT and the model is a minimum. Common waveshaper algorithms typically contain one or more parameters that allow the shape of the waveshaper to be controlled. For example, a polynomial waveshaper could have a parameter that controls the order of the polynomial. The higher the order, the “harder” the knee of the waveshaper. Other waveshaper algorithms exist with differing methods of controlling the shape.

Also important in waveshaper performance is the symmetry of the waveshaper. A perfectly symmetric waveshaper will generate only even harmonics. As asymmetry is introduced odd harmonics begin to be generated. If desired, the ratio of the harmonics can be measured and the model adjusted to minimize the difference between the model and the DUT. Other techniques exist including calculating a histogram of the waveshaper outputs and comparing those. A symmetric waveshaper will have a symmetric histogram and vice-versa.

Another metric to be considered is a compression characteristic. Tube amplifiers experience supply voltage sag due to finite resistance in the supply circuitry. This is actually a desirable characteristic as it leads to a compression of the output reducing dynamic range. This also generates a desirable attack characteristic as the signal envelope will have more energy at the beginning. The user perceives this as the amplifier having a “punchy” quality which increases the enjoyment of the performance.

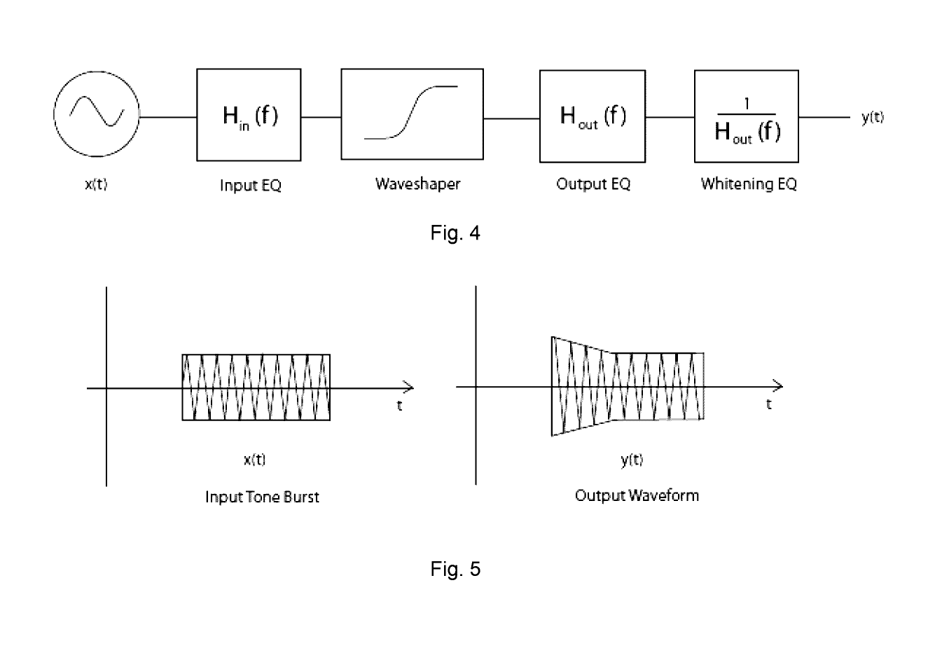

FIG. 4 illustrates an example of measuring the compression. The corrective output EQ found earlier is inverted to “whiten” the output spectrum of the DUT. In some example, the input EQ can also be whitened. A high-amplitude burst of noise or a sine wave burst or other stimulus burst is applied to the input of the DUT. The envelope of the output signal is then recorded and measured. Whitening the output simplifies the measurement to a straightforward rectification and envelope detector as the white spectrum ensures there are no transient behaviors due to nonlinear frequency response. Since the spectrum is flat the transient behavior is only that of the waveshaper.

As shown in FIG. 5, the output waveform is similar to the applied burst but with an exponential decay of the envelope. This envelope is easily measured and the amount of the compression can be calculated. The associated time constant of the decay can also be measured if desired.

The response of the simulation model is then measured using the same burst stimulus. The compression parameters are similarly calculated and compared to the DUT parameters. Internal model parameters are then adjusted and the measurement repeated. This procedure is iterated until the response of the model matches that of the DUT.

At this point the simulation consists of the original model plus a set of corrective data. The corrective data includes input EQ, output EQ, waveshaper parameters and compression parameters. This data is saved along with the original model data to form a corrected model. Typically the EQ data is saved as FIR filter coefficients while the other data is saved as parametric data. The resulting corrected model is then available to the user as a custom simulation model.

To further improve the user experience it is desirable to make the model controls behave as close to the DUT as possible. For example a typical guitar amplifier has gain and equalization controls. The proposed invention prompts the user to set these controls on the simulation model to match the positions of the DUT prior to the matching procedure. This ensures that the controls will react similarly to the DUT during usage. For example, if the DUT has the bass control set to ‘2’ and the treble control set to ‘7’ the user is prompted to set the simulation model controls to the same values. This supposes, however, that the simulation model controls behave similarly to the DUT which cannot always be guaranteed. Regardless this improves the user experience as the controls on the model will react similarly to the DUT during usage.

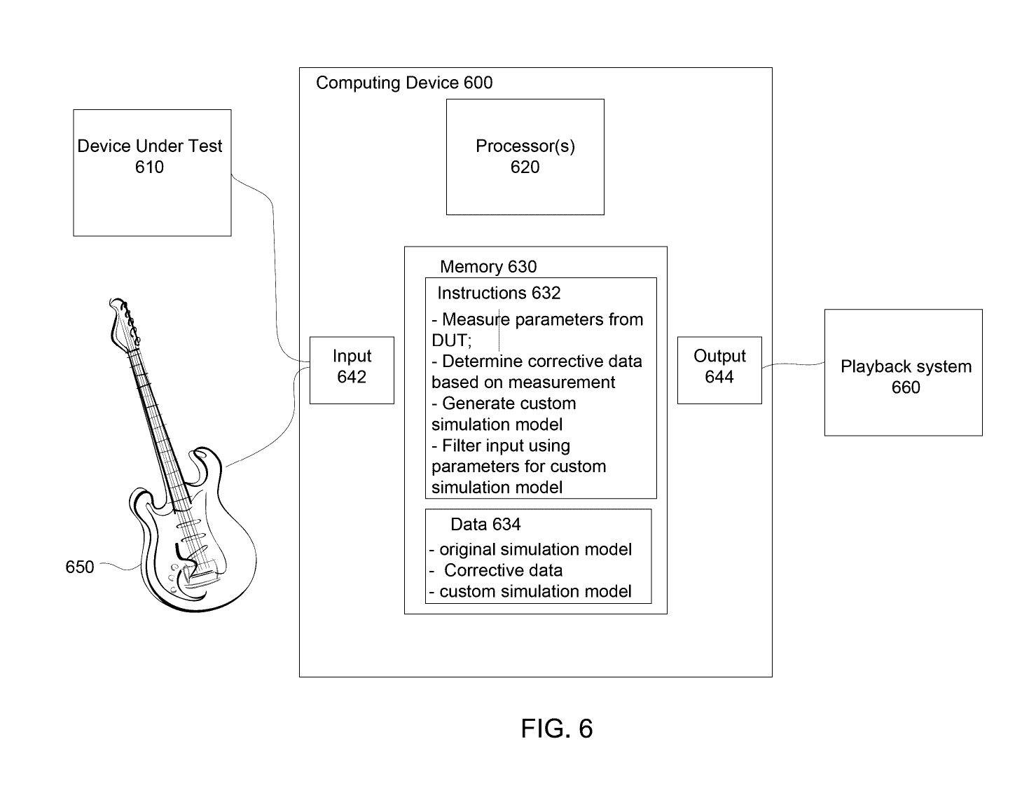

FIG. 6 illustrates an example system for performing the measurements and modeling discussed above. The system includes a computing device 600 connected between a musical instrument 650 and an external device, such as a playback system 660. The connections between the devices may include wires, cables, or any other type of connection. The playback system 660 may be a speaker cabinet, a mixer, a radio station public address, or any other device for emitting, transmitting, or further processing sound. In some examples, sound output by the guitar 650 is processed by the computing device 100 and output to the playback system 660 with near-zero latency.

A device under test (DUT) 610 is also coupled to the computing device 600. For example, the DUT 610 may be coupled by wires. According to another example, sound emitted from the DUT 610 may be captured by a microphone (not shown) coupled to the computing device 600. In this regard, sound emitted from the DUT 610 may be received and measured by the computing device 600.

Computing device 600 may contain a processor 620, memory 630 and other components typically present in general purpose computers. The computing device 600 may be, for example, one or more chips such as digital signal processors on a circuit board, a general purpose computer, an arrangement of interconnected computing devices, or the like. Moreover, the computing device 600 can be embedded in another device, such as a mobile telephone, a personal digital assistant (PDA), a mobile audio or video player, or a portable storage device (e.g., a universal serial bus (USB) flash drive).

Input 642 is configured to receive a signal from the guitar 650. The input may be a port in communication with the processor 620. In some examples, the input 642 includes an analog-to-digital converter configured to convert an analog signal received from the guitar 650 to a digital signal for use by the processor. Similarly, output 644 is configured to provide a signal to the playback system 660, and may include a digital-to-analog converter for transforming the processed digital signal back into analog form. While only one input 642 is shown, it should be understood that multiple inputs may be included in the computing device 600. For example, a first input may be designated for receiving input from a musical instrument, while a second input is designated for receiving input from a DUT. Similarly, multiple outputs may also be included.

The processor 620 may be any processor suitable for the execution of a computer program including, by way of example, a digital signal processor, both general and special purpose microprocessors, a dedicated controller, such as an ASIC, or any one or more processors of any kind of digital computer. The processor 620 receives instructions 632 and data 634 from memory 630.

Memory 630 of computing device 600 stores information accessible by processor 620, including instructions 632 that may be executed by the processor 620. Memory also includes data 634 that may be retrieved, manipulated or stored by the processor. The memory may be of any type capable of storing information accessible by the processor, such as a hard-drive, memory card, ROM, RAM, DVD, CD-ROM, write-capable, and read-only memories. The memory 630 may include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The instructions 632 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance.

Data 634 may be retrieved, stored or modified by processor 620 in accordance with the instructions 632. For instance, although the system and method is not limited by any particular data structure, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data.

The data 634 may include, for example, simulation models of amplifiers. For example, the simulation models may include information, such as an impulse response, related to filters used for processing signals output by the guitar 650. The data 634 may further include parameters measured from the DUT 610, such as output equalization, total equalization, gain, distortion, compression, etc. In some examples, the data 634 may further include information related to an input signal, such as parameters of the guitar 650.

The instructions 632 provide for measuring the parameters from the DUT 610, determining corrective data based on measurement, generating a custom simulation model based on the corrective data and the simulation model, and filtering input using parameters for the custom simulation model.

Although FIG. 6 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

Moreover, it should be understood that the computing device 600 is an illustrative example only. Implementations of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs. Alternatively or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The computing device 600 can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program can be written in any form of programming language and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Embodiments of the subject matter described herein can be implemented on mobile phones, smart phones, tablets, personal digital assistants, and computers having display devices, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, tactile feedback, etc.; and input from the user can be received in any form, including acoustic, speech, tactile input, etc. In addition, a computer can interact with a user by sending documents to and receiving documents from a device that is used by the user; for example, by sending web pages to a web browser on a user's client device in response to requests received from the web browser.

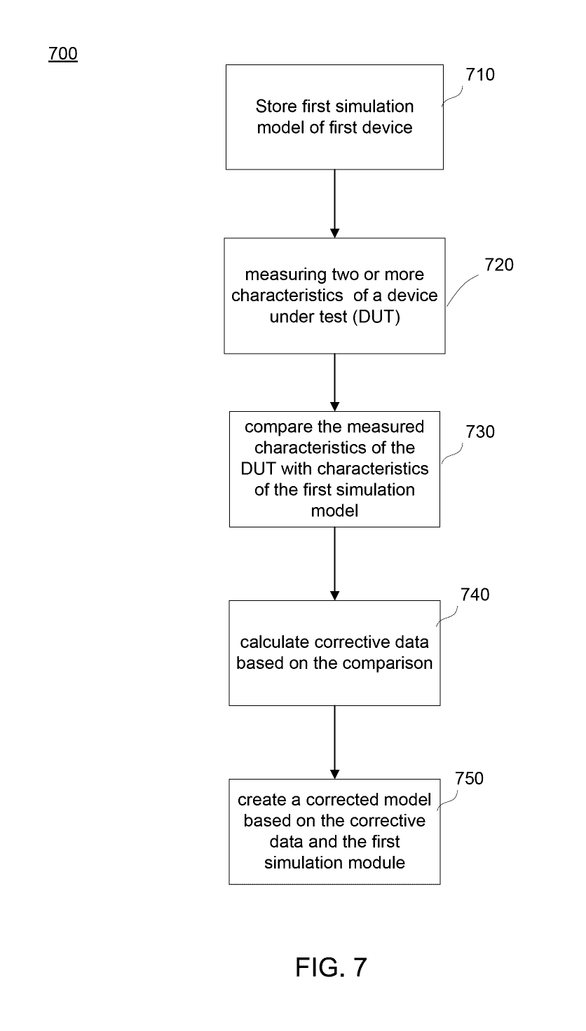

FIG. 7 provides an example flow diagram 600 illustrating a method of automatically matching the sound of an amplifier, speaker, or other DUT. The method may be performed by, for example, one or more processors such as described in connection with FIG. 6. While the operations are described in a particular order, the operations may be executed in a different order or particular operations may be executed simultaneously. Moreover, operations may be added or omitted.

In block 710, a first simulation model of a first device is provided. The first device may correspond, to some degree, to the DUT. For example, the DUT may be a particular high-end brand/model amplifier that a user desires to simulate. The first device may be the same brand or the same brand and model. The first simulation model may one or more filters applied to an input signal to make the signal sound as if it is played through the first device. However, while the first device and the DUT may be the same brand and even the same model, the sound of the DUT may be different, for example, due to age or other factors.

In block 720, characteristics of the DUT are measured. The characteristics may include at least two or more of equalization, gain, distortion, and compression. Measuring the characteristics may include receiving an input from the DUT. For example, sound may be played through the DUT and recorded. Alternatively or additionally, the DUT may be stimulated with high and low amplitude sine sweeps, a burst, or other stimuli. Accordingly, responses to the stimulus may be detected.

In block 730, the measured characteristics of the DUT are compared with characteristics of the first simulation model. The characteristics of the first simulation model may be known, for example, based on specifications or other information used to create and store the first simulation model. In some examples, the characteristics of the first simulation model may be measured similar to measuring the characteristics of the DUT. Such measurement may be performed before, during, or after measurement of the DUT characteristics.

In block 740, corrective data is calculated based on the comparison. For example, the corrective data may include a waveshaper, input equalization, output equalization, compression characteristics, etc.

In block 750, a corrected model is created based on the corrective data and the first simulation model. For example, the corrective data may be applied to the first simulation model, such that the resulting corrected model includes characteristics more closely matching those of the DUT. According to some examples, characteristics of the corrected model may be measured and the comparison to the DUT characteristics, calculation of further corrective data, and update of the corrected model may be repeated.

Using the above-described techniques, a user may model the sound of a desired amplifier so closely that the difference is indistinguishable to a human ear. By determining the input equalization and by modeling various characteristics of the DUT, filtering an input signal using the corrected model may produce a nearly identical sound to playing through the DUT.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. In some cases, the actions recited in the claims can be performed in a different order and still achieve desirable results. Moreover, the separation of various system components in the embodiments described above should not be understood as requiring such separation in all embodiments, and it should be understood that the described program components and systems can generally be integrated together in a single software product or packaged into multiple software products.

As these and other variations and combinations of the features discussed above can be utilized without departing from the subject matter as defined by the claims, the foregoing description of exemplary aspects should be taken by way of illustration rather than by way of limitation of the subject matter as defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A method comprising:
storing a first simulation model of a first device, the first simulation model including characteristics;
measuring, with one or more processors, characteristics of a device under test (DUT), the characteristics of the DUT including two or more of equalization, gain, distortion, and compression;
comparing, with the one or more processors, the measured characteristics of the DUT with the characteristics of the first simulation model;
calculating, with the one or more processors, corrective data based on the comparison; and
creating a corrected model based on the corrective data and the first simulation module.

2. The method of claim 1, wherein comparing the characteristics of the DUT with the characteristics of the first simulation model comprises matching transfer functions of the DUT with transfer functions of the first simulation model.

3. The method of claim 1, wherein measuring equalization comprises measuring an output equalization and measuring a total equalization for the DUT.

4. The method of claim 3, further comprising calculating an input equalization using the output equalization and the total equalization for the DUT.

5. The method of claim 3, wherein measuring the output equalization comprises stimulating the DUT with a high amplitude sine sweep, and wherein measuring the total equalization comprises stimulating the DUT with a low amplitude sine sweep.

6. The method of claim 3, wherein measuring the compression of the DUT comprises:
computing, with the one or more processors, an inverse of the output equalization;
applying a stimulus burst to an input of the DUT; and
recording an output signal of the DUT.

7. The method of claim 6, wherein the stimulus burst is one of a high-amplitude burst of noise and a sine wave burst.

8. The method of claim 1, wherein measuring the distortion of the DUT comprises:
measuring the resulting gain of the DUT;
comparing the resulting gain of the DUT to an input amplitude to the DUT; and
determining a shape of a transfer function of the DUT based on the comparison.

9. The method of claim 1, further comprising:
measuring, with the one or more processors, characteristics of the corrected model;
comparing, with the one or more processors, the measured characteristics of the DUT with the measured characteristics of the corrected model;
calculating, with the one or more processors, second corrective data based on the comparison of the measured characteristics of the DUT with the measured characteristics of the corrected model; and
updating the corrected model based on the second corrective data.

10. The method of claim 9, wherein measuring the characteristics of the corrected simulation model is performed simultaneously with the measuring of the DUT.

11. A system, comprising:
a memory storing a first simulation model of a device, the first simulation model including characteristics; and
one or more processors in communication with the memory, the one or more processors programmed to:
measure characteristics of a device under test (DUT), the characteristics of the DUT including two or more of equalization, gain, distortion, and compression;
compare the measured characteristics of the DUT with the characteristics of the first simulation model;
calculate corrective data based on the comparison; and
create a corrected model based on the corrective data and the first simulation model.

12. The system of claim 11, wherein the first device is one of an amplifier and a speaker.

13. The system of claim 11, wherein the one or more processors includes digital signal processors.

14. The system of claim 11, wherein comparing the characteristics of the DUT with the characteristics of the first simulation model comprises matching transfer functions of the DUT with transfer functions of the first simulation model.

15. A non-transitory computer-readable storage medium storing instructions executable by one or more processors for performing a method, the method comprising:
storing a first simulation model of a first device, the first simulation model including characteristics;
measuring characteristics of a device under test (DUT), the characteristics of the DUT including two or more of equalization, gain, distortion, and compression;
comparing the measured characteristics of the DUT with the characteristics of the first simulation model;
calculating corrective data based on the comparison of the measured characteristics of the DUT with the characteristics of the first simulation model; and creating a corrected model based on the corrective data and the first simulation model.

16. The non-transitory computer-readable storage medium of claim 15, wherein comparing the characteristics of the DUT with the characteristics of the first simulation model comprises matching transfer functions of the DUT with transfer functions of the first simulation model.

17. The non-transitory computer-readable storage medium of claim 15, wherein measuring equalization comprises measuring an output equalization and measuring a total equalization for the DUT, and wherein the method further comprises calculating an input equalization using the output equalization and the total equalization.

18. The non-transitory computer-readable storage medium of claim 17, wherein measuring the output equalization comprises stimulating the DUT with a high amplitude sine sweep, and wherein measuring the total equalization comprises stimulating the DUT with a low amplitude sine sweep.

19. The non-transitory computer-readable storage medium of claim 17, wherein measuring the compression of the DUT comprises:
computing an inverse of the output equalization;
applying a stimulus burst to an input of the DUT; and
recording an output signal of the DUT.

20. The non-transitory computer-readable storage medium of claim 15, wherein measuring the distortion of the DUT comprises:
measuring the resulting gain of the DUT;
comparing the resulting gain of the DUT to an input amplitude to the DUT; and
determining a shape of a transfer function of the DUT based on the comparison.

21. The non-transitory computer-readable storage medium of claim 15, further comprising:
measuring characteristics of the corrected model;
comparing the measured characteristics of the DUT with the measured characteristics of the corrected model;
calculating second corrective data based on the comparison of the measured characteristics of the DUT with the measured characteristics of the corrected model; and
updating the corrected model based on the second corrective data.

22. The non-transitory computer-readable storage medium of claim 21, wherein measuring the characteristics of the corrected simulation model is performed simultaneously with the measuring of the characteristics of the DUT.

23. A method of manufacturing a simulation device, comprising:
storing a first simulation model of a first device, the first simulation model including characteristics;
providing an input for receiving information from a device under test (DUT);
providing one or more processors programmed to:
measure the received information;
determine characteristics of the DUT based on the received information, the characteristics including two or more of equalization, gain, distortion, and compression;
compare the measured characteristics of the DUT with the characteristics of the first simulation model;
calculate corrective data based on the comparison; and
create a corrected model based on the corrective data and the first simulation module.

24. A method of simulating a device under test (DUT), comprising:
selecting, on a signal processing device, a first simulation model having characteristics approximating characteristics of the DUT;
inputting information from the DUT to the signal processing device;
inputting at least one command, the at least one command causing one or more processors in the signal processing device to:
measure the information from the DUT;
determine characteristics of the DUT based on the information, the characteristics including two or more of equalization, gain, distortion, and compression;
compare the measured characteristics of the DUT with the characteristics of the first simulation model;
calculate corrective data based on the comparison; and
create a corrected model based on the corrective data and the first simulation module.
